(19) United States
(12) Patent Application Publication
(10) Pub. No.: US 2017/0097099 A1
(43) Pub. Date: Apr. 6, 2017

(54) SYSTEM AND METHOD FOR VALVE ASSEMBLY

(71) Applicant: Cameron International Corporation, Houston, TX (US)

(72) Inventors: Ralph Dixon O'Nan, Moore, OK (US); Ricky Allen Jones, Newcastle, OK (US)

(21) Appl. No.: 14/873,798

(22) Filed: Oct. 2, 2015

(51) Int. Cl. F16K 5/06; B23P 15/00

(52) U.S. Cl. CPC F16K 5/06; B23P 15/001

(57) ABSTRACT

A method for assembling a ball valve using a system having a support structure and a tool includes positioning a body of the ball valve on a surface of the support structure. The method also includes driving one or more engaging members of the tool radially outward from a retracted position to an expanded position to engage a seat disposed within the body of the ball valve. The method further includes adjusting an axial position of the surface of the support structure relative to the one or more engaging members of the tool while the seat is engaged by the one or more engaging members of the tool to drive the seat into a seated position within the body of the ball valve.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Ball valves may be employed to regulate a flow of fluid in a variety of applications. Ball valves may include a body, a seat disposed within the body, and a ball positioned adjacent to the seat. During assembly of the ball valve, heavy equipment is typically utilized by an operator to manually drive the seat into a seated position within the body and/or to install the ball. Unfortunately, such assembly methods may be arduous and inefficient, and may cause wear and/or damage to the components of the ball valve (e.g., the ball and/or the seat).

### BRIEF DESCRIPTION OF THE DRAWINGS

Various features, aspects, and advantages of the present invention will become better understood when the following detailed description is read with reference to the accompanying figures in which like characters represent like parts throughout the figures, wherein:

FIG. 1 is a schematic of an embodiment of a system configured to facilitate assembly of a ball valve;

FIG. 2 is cross-sectional side view of a portion of the system of FIG. 1, taken within line 2-2, illustrating a seat in a first position within a body of the ball valve;

FIG. 3 is a cross-sectional side view of the portion of the system of FIG. 2, illustrating a tool inserted within the body of the ball valve;

FIG. 4 is a cross-sectional side view of the portion of the system of FIG. 2, illustrating engaging members of the tool in an expanded position to engage the seat;

FIG. 5 is a cross-sectional side view of the portion of the system of FIG. 2, illustrating the seat in a second position within the body of the ball valve to facilitate installation of a ball and a trunnion;

FIG. 6 is a cross-sectional side view of the portion of the system of FIG. 2, illustrating the seat, the ball, and the trunnion installed within the body of the ball valve and the tool in a withdrawn position;

FIG. 7 is a perspective view of the tool that may be part of the system of FIG. 1;

FIG. 8 is a flow diagram of an embodiment of a method of assembling the ball valve using the system of FIG. 1; and

FIG. 9 is a schematic of an embodiment of a hydraulic fluid system that may be part of the system of FIG. 1.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Embodiments of the present disclosure may reduce the labor and time associated with assembly of a ball valve. As will be appreciated, ball valves include a body (e.g., annular valve body), a seat (e.g., annular seat) disposed within the body, and a ball positioned within the body and adjacent to the seat. A trunnion (e.g., stem) may extend through the ball and may be configured to cause rotation of the ball relative to the body to control a flow of fluid through the ball valve. The disclosed embodiments include a system having a tool (e.g., mandrel) and a support structure (e.g., table or platform). The tool may be configured to engage the seat and a surface of the support structure may be configured to support the body and to move relative to the tool to facilitate installation of the seat, the ball, and/or the trunnion within the body of the ball valve. The disclosed embodiments may advantageously enable efficient assembly of the valve and/or may reduce an amount of manual labor associated with assembly of the ball valve. In some cases, the disclosed embodiments may reduce wear and/or damage to the components of the valve during valve assembly.

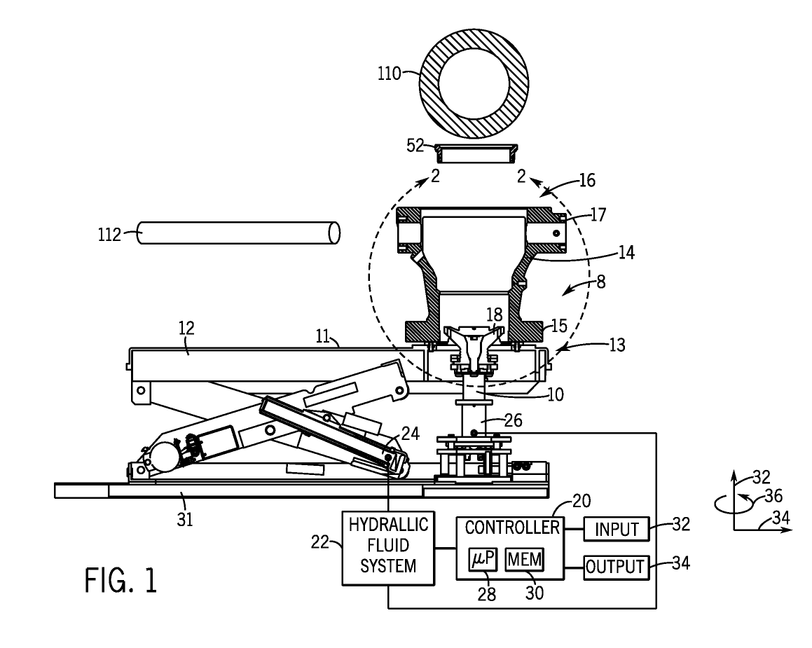

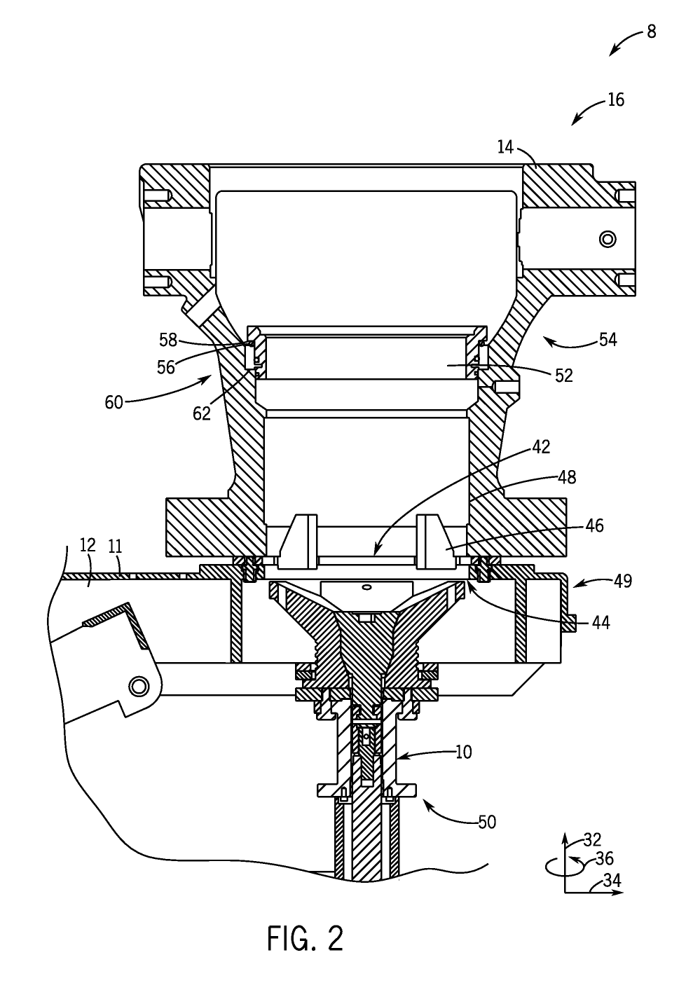

FIG. 1 is a schematic of an embodiment of a system 8 (e.g., a ball valve assembly system) that is configured to facilitate assembly of a valve 16 (e.g., ball valve). The system 8 includes a tool 10 (e.g., mandrel) and a support structure 12 (e.g., table or platform). The support structure 12 is configured to support a body 14 (e.g., annular valve body) of the valve 16 during assembly of the valve 16. As discussed in more detail below with respect to FIGS. 2-9, an upper surface 11 (e.g., a supporting surface or an axially-facing surface) of the support structure 12 may move between a raised position (e.g., first position) and a lowered position 13 (e.g., second position) to facilitate installation of a seat 52 (e.g., annular seat), a ball 110, and/or a trunnion 112 (e.g., stem) within the valve 16. For example, the upper surface 11 of the support structure 12 may move from the raised position in which the tool 10 is positioned below the upper surface 11 of the support structure 12 to the illustrated lowered position 13 to cause insertion of the tool 10 into the body 14 of the valve 16. While the tool 10 is inserted within the body 14 of the valve 16, the tool 10 may engage the seat 52 (e.g., via radial expansion of engaging members 18 of the tool 10). While the tool 10 engages the seat 52 and holds the seat 52 at a fixed axial position, the upper surface 11 of the support structure 12 may move upward from the lowered position 13, thereby moving the body 14 upward relative to the seat 52 and driving the seat 52 into a seated position within the body 14 of the valve 16. While the seat 52 is engaged and held (e.g., maintained) in the seated position by the tool 10, a passageway extending through the ball 110 may align with a passageway extending through the body 14, thereby enabling insertion of the trunnion 112 through the respective passageways of the ball 110 and the body 14. Following insertion of the trunnion 112, the tool 10 may disengage from the seat 52 and may be withdrawn from the body 14 of the valve 16 (e.g., via upward movement of the support structure 12 to the raised position).

Thus, the ball 110 may be installed against the seat 52 and may be rotationally coupled to the trunnion 112 such that rotation of the trunnion 112 causes the ball 110 to rotate within the body 14. In particular, the ball 110 is configured to rotate between an open position and a closed position. The ball 110 includes a bore that facilitates the passage of fluid through the valve 16. In the open position, the bore of the ball 110 is aligned with respective closures 15, 17 (e.g., annular closures) that are configured to connect to fluid conduits to enable fluid to pass through the valve 16. In the closed position, the bore is rotated relative to (e.g., perpendicular to) the closures 15, 17, thereby substantially blocking the flow of fluid through the valve 16. As will be appreciated, rotating the ball 110 to an orientation between the open and closed positions may establish a desired flow rate of fluid through the valve 16.

As shown, the system 8 includes a controller 20 that is configured to control movement of the support structure 12 and/or the tool 10. In some embodiments, the controller 20 may be configured to control a fluid system 22, such as a hydraulic fluid system, having a fluid actuator or a fluid drive with one or more fluid lines, valves, chambers, cylinders, pistons, pumps, motors, or the like. In some embodiments, the controller 20 may be configured to control the fluid system 22 (e.g., the valves, the pump, etc.) to adjust a position of a hydraulic cylinder 24 of the support structure 12 (e.g., a position of piston of the hydraulic cylinder 24 via pressure from a pump or a motor), thereby adjusting the position of the upper surface 11 of the support structure 12 (e.g., along an axial axis or direction 32). In some embodiments, the controller 20 may control the fluid system 22 to adjust a position of a hydraulic cylinder 26 of the tool 10 (e.g., a position of piston of the hydraulic cylinder 26 via pressure from a pump or a motor), thereby adjusting a position of the tool 10 or a position of a component of the tool 10 (e.g., along the axial axis 32). For example, in some embodiments, adjusting the position of the piston of the hydraulic cylinder 26 may cause the engaging members 18 of the tool 10 to engage or to disengage from the seat 52.

In certain embodiments, the controller 20 is an electronic controller having electrical circuitry configured to control various components of the system 8, such as the fluid system 22. In the illustrated embodiment, the controller 20 includes a processor, such as the illustrated microprocessor 28, and a memory device 30. The controller 20 may also include one or more electronic data storage devices and/or other suitable components. The processor 28 may be used to execute software (e.g., instructions or code), such as software for controlling the fluid system 22, for receiving operator inputs via an input device 32, for receiving inputs from one or more sensors or switches, for providing an output indicative of the condition of the valve 16 via an output device 34, and so forth. For example, the processor 28 may be configured to receive an operator input to initiate assembly of the valve 16, and the processor 28 may control the fluid system 22 (e.g., a valve, pump, motor, drive, actuator, etc. of the fluid system 22) to adjust the upper surface 11 of the support structure 12 and/or the tool 10 to install the seat 52, the ball 110, and/or the trunnion 112 within the valve 16, as set forth below. In some embodiments, the processor 28 may be configured to receive an operator input indicative of characteristics (e.g., size, valve family, model, part numbers, serial numbers, or the like) of the valve 16, and the processor 28 may control the fluid system 22 to adjust the upper surface 11 of the support structure 12 and/or the tool 10 based on appropriate parameters (e.g., valve-specific parameters) accessed and/or selected from the memory 30, for example. In some embodiments, the output device 34 may provide an indication (e.g., a visually displayed or audible indication) that installation of the seat 52, the ball 110, and/or the trunnion 112 is complete. Moreover, the processor 28 may include multiple microprocessors, one or more “general-purpose” microprocessors, one or more special-purpose microprocessors, and/or one or more application specific integrated circuits (ASICS), or some combination thereof. For example, the processor 28 may include one or more reduced instruction set (RISC) processors.

The memory device 30 may include a volatile memory, such as random access memory (RAM), and/or a nonvolatile memory, such as read-only memory (ROM). The memory device 30 may store a variety of information and may be used for various purposes. For example, the memory device 30 may store processor-executable instructions (e.g., firmware or software) for the processor 28 to execute, such as instructions for controlling the fluid system 22 to adjust the position of the upper surface 11 of the support structure 12 and/or to adjust components of the tool 10. The storage device(s) (e.g., nonvolatile storage) may include ROM, flash memory, a hard drive, or any other suitable optical, magnetic, or solid-state storage medium, or a combination thereof. The storage device(s) may store data (e.g., position data, etc.), instructions (e.g., software or firmware for controlling the fluid system 22, etc.), and any other suitable data. In the illustrated embodiment, the support structure 12 includes a base 31 (e.g., fixed or stationary base 31). In some embodiments, the tool 31 may be coupled (e.g., fixed) to the base 31, and the upper surface 11 of the support structure 12 may be configured to move relative to the base 31 and to the tool 10 along the axial axis 32. To facilitate discussion, the system 8 and its components may be described with reference to the axial axis or direction 32, a radial axis or direction 34, and a circumferential axis or direction 36.

FIG. 2 is cross-sectional side view of a portion of the system 8 prior to installation of the ball and/or the trunnion within the valve 16. As shown, the body 14 of the valve 16 is positioned on and supported by the upper surface 11 of the support structure 12. When properly positioned on the support structure 12, an opening 42 of the body 14 is substantially aligned with an opening 44 of the support structure 12. A locating tab 46 (e.g., one or more tabs positioned at discrete circumferential locations or an annular ring disposed about the opening 44) may be provided to engage a wall 48 (e.g., annular wall) of the body 14 and to facilitate alignment of the openings 42, 44.

Prior to assembly of the valve 16 and/or during placement of the body 14 on the support structure 12, the upper surface 11 may be in a raised position 49 and/or the tool 10 may be positioned below the upper surface 11 (e.g., along the axial axis 32) in a withdrawn position 50 (e.g., withdrawn from or outside of the body 14 of the valve 16). As shown, a seat 52 (e.g., annular seat) is in a first position 54 (e.g., unseated or raised position) within the body 14 of the valve 16. In certain embodiments, a biasing member 56 (e.g., annular biasing member or spring) may be coupled to the seat 52. In the illustrated embodiment, the biasing member 56 is coupled to an axially-facing surface 58 of the seat 52. As discussed below, the biasing member 56 may be configured to contact a surface, such as an axially-facing surface 62, of the body 14 when the seat 52 is installed within the body 14. Thus, the biasing member 56 may be configured to bias or urge the seat 52 toward the ball when the seat 52 and the ball are installed in the valve 16, thereby facilitating contact between the ball and the seat 52 during operation of the valve 16. When the seat 52 is in the illustrated first position 54, the biasing member 56 may be in an uncompressed state 60. It should be understood that in certain embodiments, the biasing member 56 may be coupled to the body 14 (e.g., the axially-facing surface 62 of the body 14) or may otherwise be positioned between any suitable surfaces, such as axially-facing surfaces 58, 62, of the seat 52 and the body 14 to bias the seat 52 toward the ball.

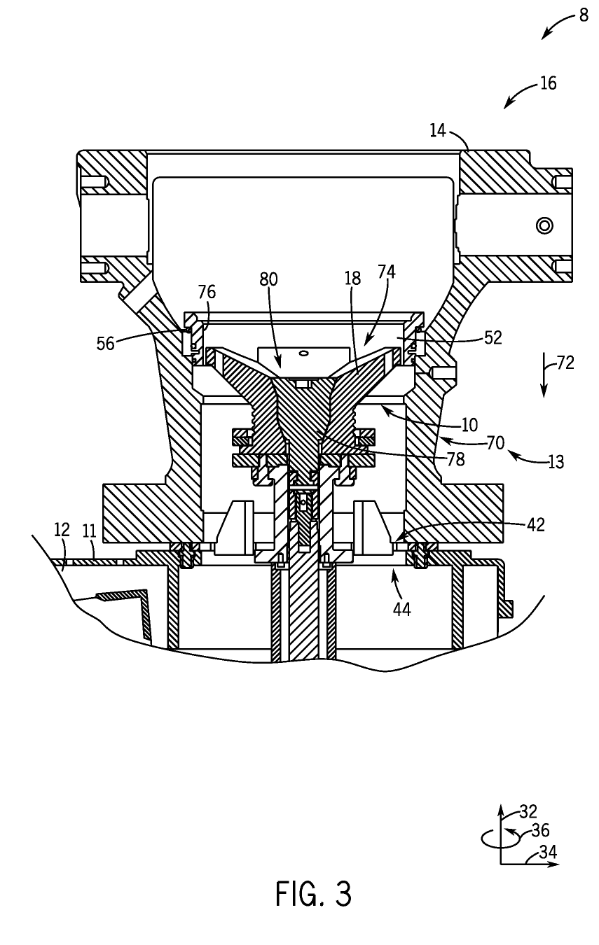

FIG. 3 is a cross-sectional side view of the portion of the system 8 having the tool 10 in an inserted position 70 in which the engaging members 18 of the tool 10 are positioned within the body 14 of the valve 16 and are axially-aligned with the seat 52. In certain embodiments, the upper surface 11 of the support structure 12 may be configured to move relative to the tool 10 to cause the tool 10 to move from the withdrawn position 50 to the inserted position 70. For example, the support structure 12 may be configured to move the upper surface 11 downward along the axial axis 32, as shown by arrow 72, from the raised position 48 to the lowered position 13 while the tool 10 remains stationary. As the upper surface 11 of the support structure 12 moves downward, at least a portion of the tool 10 (e.g., the engaging members 18) may pass through the opening 44 of the support structure 12 and/or through the opening 42 of the body 14 of the valve 16. As discussed in more detail below, the engaging members 18 may be physically separate segments (e.g., fingers, arms, or jaws) positioned at discrete circumferential locations about the tool 10. The engaging members 18 may have a geometry or configuration (e.g., circumferentially-spaced gaps) that enable the engaging members 18 to move axially past the locating tabs 46.

As shown, the engaging members are in a retracted position 74 (e.g., radially-retracted position). In the retracted position 74, a pin 78 (e.g., a central drive member) is in a first position 80 (e.g., raised position), which enables the engaging members 18 to fit within the seat 52 and to avoid contact and/or engagement with an inner annular wall 76 of the seat 52. It should be understood that additionally or alternatively, the tool 10 may be configured to move upward along the axial axis 32 relative to the upper surface 11 and/or the base 31 of the support structure 12 from the withdrawn position 50 to the inserted position 70.

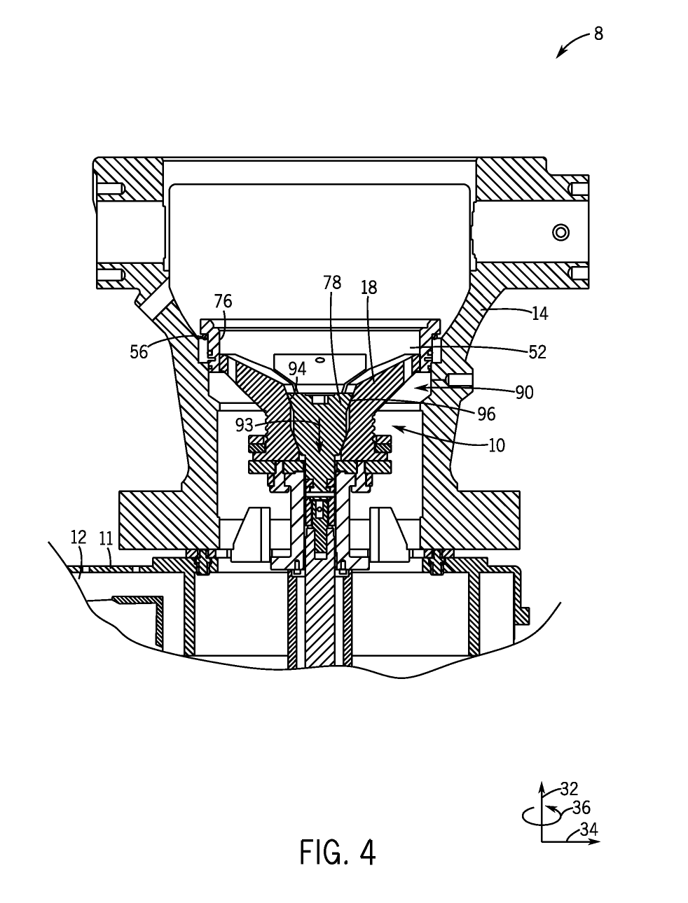

FIG. 4 is a cross-sectional side view of the portion of the system 8 of FIG. 2 with the engaging members 18 of the tool 10 in an expanded position 90 (e.g., radially-expanded position) in which the engaging members 18 contact and/or engage the inner wall 76 of the seat 52. In certain embodiments, the pin 78 is configured to move axially to a second position 92 (e.g., lowered position), as shown by arrow 93. In the illustrated embodiment, at least a portion of an outer surface 94 of the pin 78 has a conical or tapered shape, and at least a portion of an inner surface 96 of the engaging members 18 has a corresponding tapered shape. Thus, movement of the pin 78 to the second position 92 drives the engaging members 18 radially outward to engage the inner wall 76 of the seat 52.

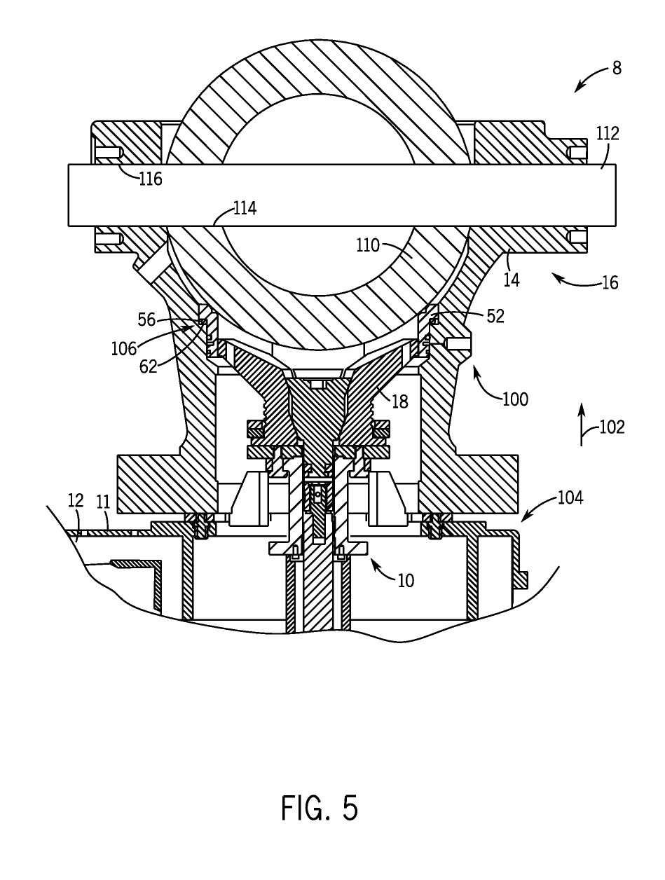

FIG. 5 is a cross-sectional side view of the portion of the system 8 showing the seat 52 in a second position 100 (e.g., seated position) within the body 14 of the valve 16. To drive the seat 52 into the second position 100 within the body 14, the system 8 causes the body 14 and the seat 52 to move relative to one another. For example, in some embodiments, the upper surface 11 of the support structure 12 may move upward as shown by arrow 102 to an intermediate position 104 (e.g., between the lowered position 13 and the raised position 49) while the engaging members 18 engage and hold the seat 52 at a fixed axial position. Such movement of the upper surface 11 causes the body 14 to move upward relative to the seat 52 such that the seat 52 reaches (e.g., attains) the second position 100 within the body 14 of the valve 16. In the second position 100, the biasing member 56 contacts the axially-facing surface 62 of the body 14 and is in a compressed state 106. It should be understood that additionally or alternatively, the engaging members 18 may move downward along the axial axis 32 relative to the upper surface 11 of the support structure 12 to cause the seat 52 to move into the second position 100 within the body 14 of the valve 16.

Driving the seat 52 into the second position 100 within the body 14 may facilitate installation of a ball 110 and/or a trunnion 112. During assembly of the valve 16, the ball 110 may be placed (e.g., manually by an operator and/or by a suitable device) adjacent to the seat 52 within the body 14 of the valve 16. While the seat 52 is in the second position 100 (e.g., maintained or held in the second position 100 by the tool 10), a passageway 114 through the ball 110 may align (e.g., along the axial axis 32) with a passageway 116 through the body 14, thereby facilitating efficient insertion of the trunnion 112 (e.g., without heavy tools or high force) through the aligned passageways 114, 116. Without the disclosed embodiments, the biasing member 56 may exert an upward bias on the seat 52 causing the passageways 114, 116 to misalign, thereby making insertion of the trunnion 112 more difficult.

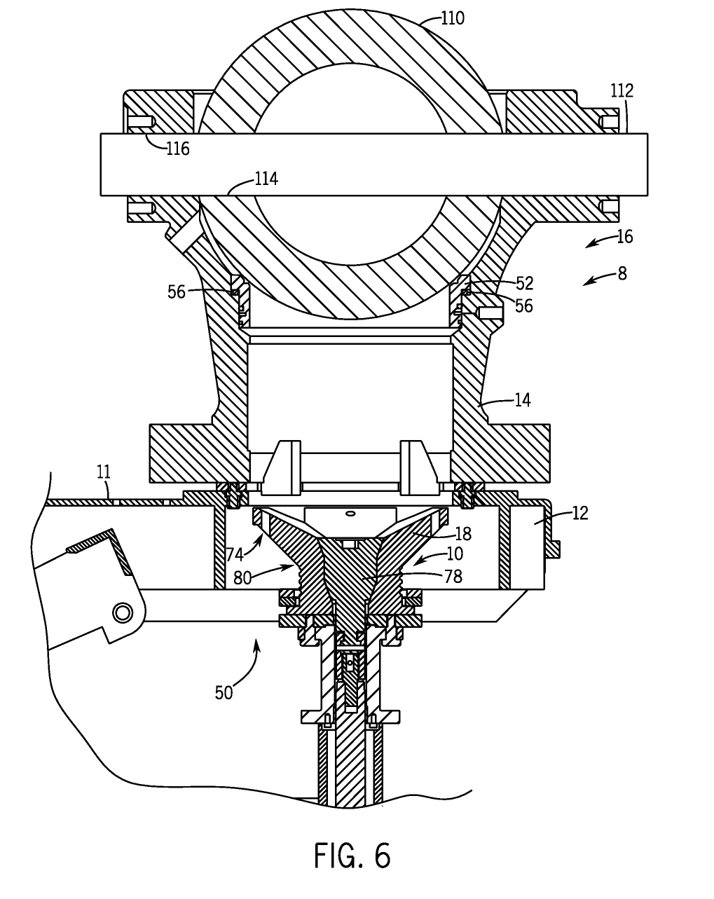

FIG. 6 is a cross-sectional side view of the portion of the system 8 with the trunnion 112 and the ball 110 installed within the body 14 of the valve 16 and the tool 10 in the withdrawn position 50. After the trunnion 112 is inserted through the ball 110 as shown in FIG. 5, the pin 78 may return to the first position 80, thereby enabling the engaging members 18 of the tool 10 to move radially inward to the retracted position 74 in which the engaging member 18 do not engage or contact the seat 52. In certain embodiments, the upper surface 11 of the support structure 12 may move upward along the axial axis 32 to the raised position, thereby causing the tool 10 to move into the withdrawn position 50 and out of the body 14 of the valve 16. However, as noted above, additionally or alternatively, the tool 10 may move relative to the support structure 12 and/or the body 14 downward along the axial axis 32 into the withdrawn position 50. When the engaging members 18 are disengaged from the seat 52, the biasing members 56 may decompress and may urge the seat 52 toward the ball 110. As shown in FIGS. 2-6, the system 8 may facilitate installation of the ball 110 and the trunnion 112 within the valve 16. Without the disclosed embodiments, the biasing member 56 may exert an upward bias on the seat 52 causing the passageways 114, 116 to misalign, thereby making insertion of the trunnion 112 more difficult. Thus, an operator may be required to use heavy equipment to manually drive the seat 52 in the second position 100, to compress the biasing member 56 to align the passageways 114, 116, and/or to drive the trunnion 112 through the passageways 114, 116. Accordingly, the disclosed embodiments may reduce the manual labor associated with assembly of the valve 16 and/or may enable efficient assembly of the valve 16. Furthermore, the disclosed embodiments may reduce wear and/or damage to the various components of the valve 16, such as the seat 52 and/or the ball 110.

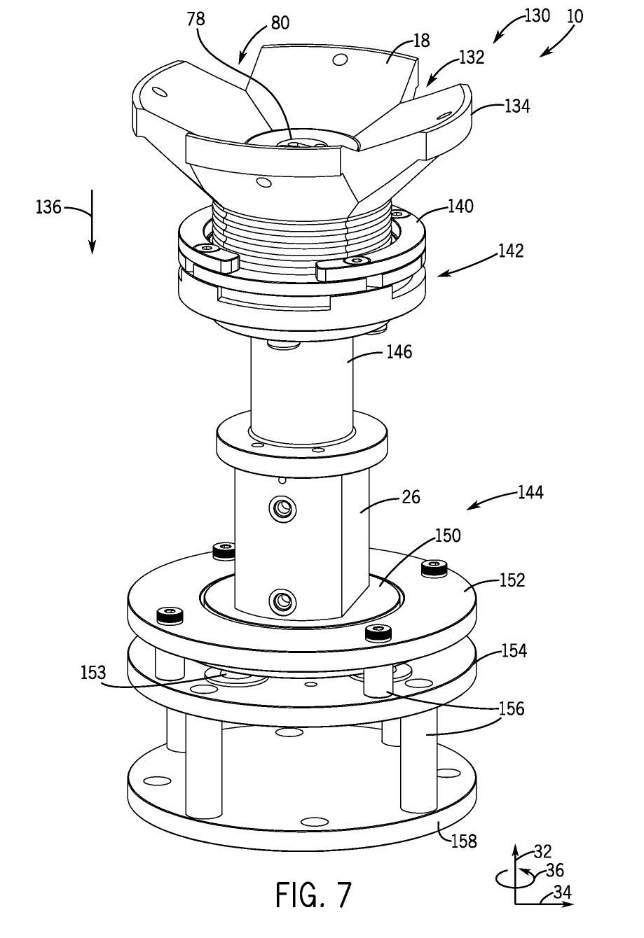

FIG. 7 is a perspective view of the tool 10. In the illustrated embodiment, the tool 10 includes four engaging members 18 spaced circumferentially (e.g., at discrete circumferential locations) about a distal end 130 of the tool 10. Although four engaging members 18 are shown, it should be understood that any suitable number (e.g., 1, 2, 3, 5, 6, 7, 8, or more) engaging members 18 may be provided. As shown, the engaging members 18 have a geometry that provides a gap 132 (e.g., a radially-extending gap or wedge) between each of the engaging members 18. The gaps 132 may enable the engaging members 18 to move past the locating tabs 46 of the support structure 12, as discussed above with respect to FIG. 2. For example, the locating tabs 46 may fit within the gaps 132 as the tool 10 moves into the inserted position 70 within the body 14 of the valve 16.

Each of the engaging members 18 is configured to move radially between the retracted position 74 and the expanded position 90. In the illustrated embodiment, the engaging members are in the retracted position 74. As discussed above, in the expanded position 90, an outer wall 134 of each engaging member 18 contacts or engages the inner wall 76 of the seat 52. In some embodiments, the outer wall 134 of each engaging member 18 is serrated (e.g., toothed with a plurality of teeth) to facilitate engagement of the inner wall 76 of the seat 52.

As discussed above, the engaging members 18 may be distributed circumferentially about the pin 78 that is configured to move up and down relative to the engaging members 18 along the axial axis 32. In some such embodiments, as the pin 78 moves axially downward from the first position 80 to the second position 92, as shown by arrow 136, the pin 78 may drive the engaging members 18 radially outward to the expanded position 90.

The pin 78 and/or the engaging members 18 may be supported by one or more plates 140 (e.g., annular plates). The engaging members 18, the pin 78, and/or the one or more plates 140 may form a removable portion 142 of the tool 10 that is removable or configured to separate from a stationary portion 144 (e.g., configured to be fixed to the base 31 of the support structure 12 and/or configured to be used with various removable portions 142) of the tool 10. In some embodiments, the system 8 may be configured to assemble valves 16 of various sizes (e.g., diameters) and it may be advantageous to efficiently change the configuration and/or the dimensions (e.g., diameter) of the engaging members 18 based on the particular valve 16 to be assembled. Thus, in some embodiments, the system 8 may include a kit having various removable portions 142 (e.g., engaging members 18 of various radial and/or axial dimensions). In some embodiments, the removable portion 142 may be coupled to the stationary portion 144 via a quick-release attachment (e.g., interlock coupling) that enables the removable portion 142 to be separated from the stationary portion 144 by rotating the pin 78 (e.g., approximately 45, 90, 180, or 360 degrees) and pulling upward (e.g., along the axial axis 32).

In some embodiments, the stationary portion 144 may include an adapter piece 146 that is configured to enable efficient separation of the pin 78. The stationary portion 144 of the tool 10 may include the hydraulic cylinder 26 that is configured to drive the pin 78 along the axial axis 32 between the first position 80 and the second position 92. As shown, the hydraulic cylinder 26 is coupled to a guide plate 150 positioned within a support plate 152. One or more casters 153 may be positioned beneath the guide plate 150 and may enable the guide plate 150 to move relative to the support plate 152. Such a configuration may enable the guide plate 150, and the engaging members 18 positioned above the guide plate 150, to move (e.g., radially and/or circumferentially) relative to the support plate 152 and/or the support structure 12 to enable proper alignment of the tool 10 with the support structure 12 and/or to enable proper engagement with the seat 52. One or more additional plates 154 and/or risers 156 may be provided beneath the support plate 152 to position the engaging members 18 at the proper height relative to the upper surface 11 of the support structure 12, for example. In some embodiments, a bottom plate 158 of the tool 10 may be coupled to the base 31 of the support structure 12, via welding, fasteners (e.g., threaded fasteners), or the like.

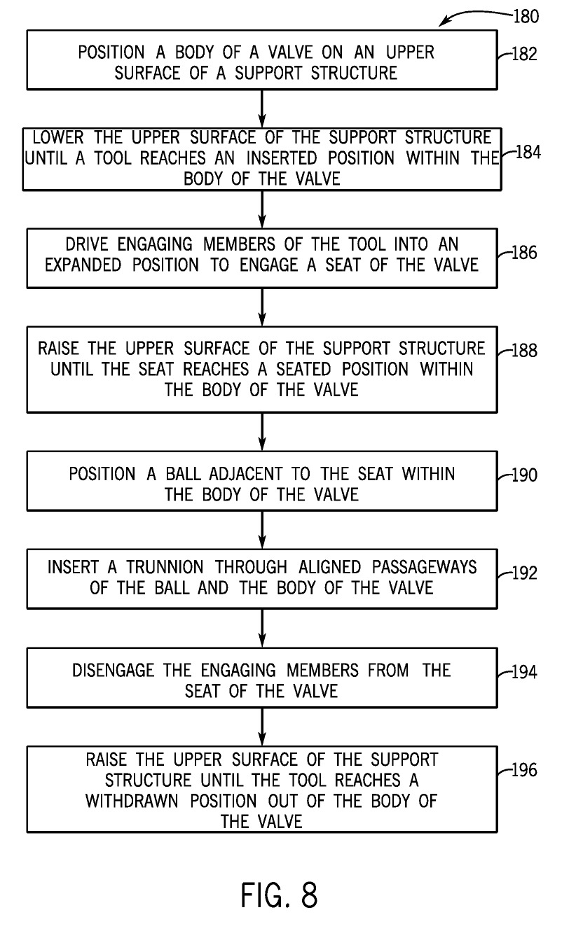

FIG. 8 is a flow diagram of an embodiment of a method 180 for installing the ball 110 within the body 14 of the valve 16 using the system 8. The method 180 includes various steps represented by blocks. It should be noted that at least some of the steps of the method 180 may be performed as an automated procedure controlled by a control system. Although the flow chart illustrates the steps in a certain sequence, it should be understood that the steps may be performed in any suitable order, and that certain steps may be omitted. Further, certain steps or portions of the methods may be performed by separate devices. For example, a first portion of the method may be performed an operator, while a second portion of the method may be performed by the processor 28 of the controller 20.

The method 180 may begin with positioning the body 14 of the valve 16 on the upper surface 11 of the support structure 12, in step 182. In some embodiments, the body 14 may be placed on the upper surface 11 of the support structure 12 by an operator and/or by suitable equipment (e.g., lifting and/or positioning equipment). In some embodiments, the upper surface 11 may be in the raised position 49 and/or the tool 10 may be in the withdrawn position 50 while the body 14 is positioned on the upper surface 11 of the support structure 12. In some embodiments, the locating tabs 46 may facilitate proper positioning of the body 14 such that the opening 42 of the body 14 is substantially aligned with the opening 44 of the support structure 12 and such that the tool 10 may be inserted into the body 14. In some embodiments, the seat 52 may be disposed in the body 14 prior to positioning the body 14 on the upper surface 11 of the support structure 12, although in some embodiments the seat 52 may be placed in the body 14 (e.g., by an operator and/or by suitable equipment) after positioning the body 14 on the upper surface 11 of the support structure 12.

In step 184, the upper surface 11 of the support structure 12 may be lowered (e.g., along the axial axis 32) from the raised position 49 to the lowered position 13 until the tool 10 reaches the inserted position 70 within the body 14 of the valve 16. In the inserted position 70, the engaging members 18 of the tool 10 may be axially-aligned with the seat 52. As discussed above, in some embodiments, the controller 20 may be configured to control components of the hydraulic fluid system 22 to adjust the hydraulic cylinder 24 of the support structure 12 to lower the upper surface 11 of the support structure 12 from the raised position 49 to the lowered position 13.

In step 186, the engaging members 18 may be driven radially from the retracted position 74 to the expanded position 90 in which the engaging members 18 contact and engage the inner wall 76 of the seat 52. As discussed above, in some embodiments, the controller 20 may be configured to control components of the hydraulic fluid system 22 to adjust the hydraulic cylinder 26 of the tool 10 to move the pin 78 axially from the first position 80 to the second position 92 to drive the engaging members 18 radially outward to engage the inner wall 76 of the seat 52.

In step 188, the upper surface 11 of the support structure 12 may be raised (i.e., to the intermediate position 104) until the seat 52 reaches the second position 100 in which the seat 52 and/or the biasing member 56 contacts the axially-facing surface 62 of the body 14 and/or in which the biasing member 56 is in the compressed state 106 (e.g., compressed between the axially-facing surface 58 of the seat 52 and the axially-facing surface 62 of the body 14). As set forth above, in some embodiments, the controller 20 may be configured to control components of the hydraulic fluid system 22 to adjust the hydraulic cylinder 24 to drive the upper surface 11 of the support structure 12 from the lowered position 13 to the intermediate position 104.

In step 190, the ball 110 may be positioned adjacent to the seat 52 within the body 14 of the valve 16. In some embodiments, the ball 110 may be placed within the body 14 by an operator and/or by suitable equipment. While the seat 52 is held in the second position 100 and while the biasing member 56 is held in the compressed state 106 (e.g., due to engagement of the seat 52 by the engaging members 18 of the tool 10), the passageway 114 extending through the ball 110 may align (e.g., along the axial axis 32) with the passageway 116 extending through the body 14. As discussed above, without the disclosed embodiments, the biasing member 56 may bias the seat 52 and/the ball 110 upward, causing the passageways 114, 116 to misalign. If the passageways 114, 116 are misaligned, the trunnion 112 may not be inserted easily (e.g., the operator may need to apply high force and/or using heavy equipment to hold the seat 52 in the second position 100 and/or to drive the trunnion 112 through the misaligned passageways 114, 116). In step 192 of the disclosed method 190, the trunnion 112 may be more easily inserted through the aligned passageways 114, 116 of the ball 110 and the body 14 of the valve 16 (e.g., with little to no force). The trunnion 112 may be inserted by an operator and/or by suitable equipment.

In step 194, the engaging members 18 may disengage from the seat 52 of the valve 16. In some embodiments, the engaging members 18 may move from the expanded position 90 to the retracted position 74 in which the engaging members 18 disengage from the inner wall 76 of the seat 52. As discussed above, in some embodiments, the controller 20 may be configured to control components of the hydraulic fluid system 22 to adjust the hydraulic cylinder 26 of the tool 10 to move the pin 78 from the second position 92 to the first position 80 to enable the engaging members 18 to move radially inward to disengage from the inner wall 76 of the seat 52.

In step 196, the upper surface 11 of the support structure 12 may be raised (e.g., along the axial axis 32) from the lowered position 13 to the raised position 49 until the tool 10 reaches the withdrawn position 50 outside of the body 14 of the valve 16. As discussed above, in some embodiments, the controller 20 may be configured to control components of the hydraulic fluid system 22 to adjust the hydraulic cylinder 24 of the support structure 12 to raise the upper surface 11 of the support structure 12 from the lowered position 13 to the raised position 49. At step 196, the seat 52, the ball 110, and the trunnion 112 are installed within the body 14 of the valve 16, and the assembled valve 16 may be removed from the support structure 12 for further processing or manufacturing steps. With the tool 10 in the withdrawn position 50, another body 14 may be positioned on the upper surface 11 of the support structure 12 to assemble another valve 16 according to steps 182-196, for example.

In some embodiments, the system 8 may be configured to assemble valves 16 of various sizes or configurations. Accordingly, the system 8 may include various size tools 10 to correspond to the various valves 16 and/or the controller 20 may be configured to facilitate assembly of various valves 16. For example, the processor 28 of the controller 20 may be configured to access (e.g., from the memory 30) a particular set of instructions for controlling the fluid drive 22 to move the upper surface 11 of the support structure 12 based on the particular valve 16 that is to be assembled. For example, the operator may input (e.g., via the input device 32) characteristics of the valve 16 (e.g., a size, a model, a type, or the like) to the controller 20, and the processor 28 may access, select, and use appropriate parameters (e.g., relative positions of the upper surface 11 and the tool 10, movement of the upper surface 11, or the like) for assembly of the valve 16 based on the input.

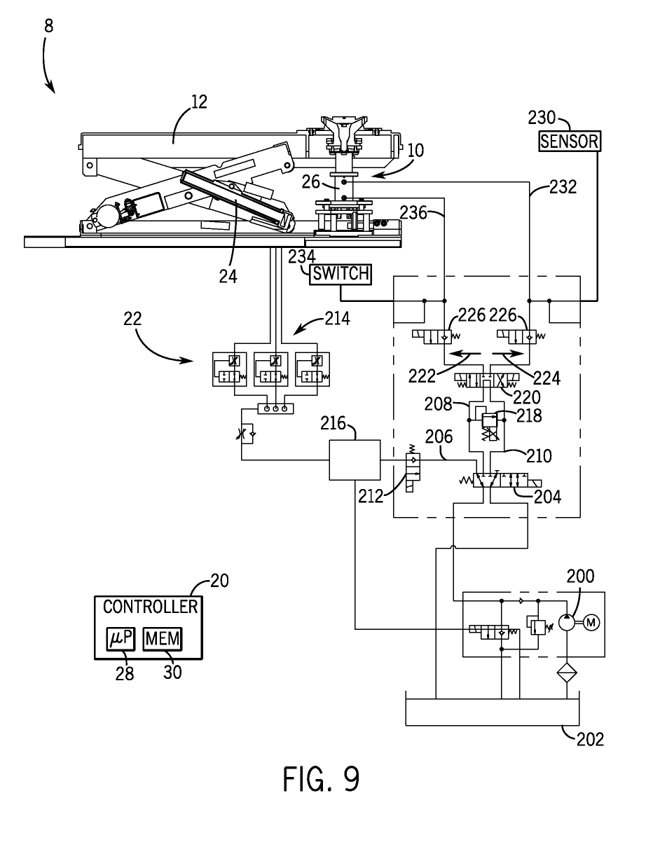

FIG. 9 is a schematic of an embodiment of the hydraulic fluid system 22 that may be part of the system 8. In the illustrated embodiment, the hydraulic fluid system 22 includes a pump 200 configured to pump a fluid from a reservoir 202. The hydraulic fluid system 22 includes various flow lines and valves configured to direct and/or adjust the flow of the fluid between the pump 200 and the hydraulic cylinders 24, 26 of the support structure 12 and the tool 10, respectively. In particular, the flow of the fluid may be directed by the various flow lines and adjusted by the various valves to adjust the position of a piston within a chamber of the hydraulic cylinder 24 of the support structure 12 and/or to adjust the position of a piston within a chamber of the hydraulic cylinder 26 of the tool 10. As discussed above, adjusting the piston of the hydraulic cylinder 24 of the support structure 12 causes the upper surface 11 of the support structure 12 to move axially and adjusting the piston of the hydraulic cylinder 26 of the tool causes the pin 78 of the tool 10 to move axially and/or the engaging members 18 of the tool 10 to move radially.

In the illustrated embodiment, the hydraulic fluid system 22 includes a first directional control valve 204. In a first position (e.g., configuration), the first directional control valve 204 is configured to direct the fluid into a first line 206 toward the hydraulic cylinder 24 of the support structure 12. In a second position, the first directional control valve 204 is configured to direct the fluid into a second line 208 and a third line 210 toward the hydraulic cylinder 26 of the tool 10.

In the illustrated embodiments, a second directional control valve 212 may be positioned along the first line 206 to maintain pressure at the hydraulic cylinder 24 when the second directional control valve 212 is in a first position and to enable a return flow of the fluid toward the reservoir 202 when the second directional control valve 212 is in a second position. As shown, one or more velocity fuses 214 may be provided to control the flow of the fluid between the hydraulic cylinder 24 of the support structure and the reservoir 202. For example, the one or more velocity fuses 214 may close or block the flow of the fluid if the flow or flow rate exceeds a predetermined threshold (e.g., stored in the memory 30). In some embodiments, such as if the hydraulic cylinder 24 is a single acting hydraulic cylinder, a bypass 216 valve (e.g., bypass valve with an adjustable limit switch) may be provided between the second directional control valve 212 and the hydraulic cylinder 24 to direct the fluid back toward the reservoir 202 when the piston within the hydraulic cylinder 24 is fully extended.

As noted above, when the first directional control valve 204 is in the second position, the fluid from the reservoir 202 may flow into the second line 208 and the third line 210. A relief valve 218 is provided to adjust pressure at the hydraulic cylinder 26, thereby adjusting the axial position of the pin 78 and the radial forces exerted by the engaging members 18 on the seat 52. A third directional control valve 220 may move between a first position in which the flow of fluid is blocked, a second position which enables the fluid to flow toward the hydraulic cylinder 26 in a first direction 222 to drive the piston of the hydraulic cylinder 26 and the pin 78 axially upward, and a third position which enables the fluid to flow toward the hydraulic cylinder 26 in a second direction 224 to drive the piston of the hydraulic cylinder 26 and the pin 78 axially downward. As discussed above, driving the pin 78 axially upward toward the first position 80 causes the engaging members 18 to radially retract to the retracted position 74, and driving the pin 78 axially downward into the second position 92 causes the engaging members to radially expand to the expanded position 90. Additional directional control valves 226 may be provided to maintain pressure at the hydraulic cylinder 26 and/or to enable a return flow of the fluid toward the reservoir 202. Although the illustrated hydraulic cylinder 26 is a double acting hydraulic cylinder, it should be understood that any suitable actuator or fluid actuator may be utilized to adjust the position of the tool 10, the pin 78, and/or the engaging members 18.

In some embodiments, the hydraulic fluid system 22 may include a sensor 230 (e.g., a pressure sensor) and/or a switch that is configured to monitor a pressure in a fluid line 232 extending between the third directional control valve 220 and the hydraulic cylinder 26. The pressure within the fluid line 232 is indicative of the pressure exerted by the engaging members 18 on the seat 52. The sensor 230 may generate a signal indicative of the pressure and may provide the signal to the processor 28 of the controller 20. In some embodiments, the tool 10 may include a sensor and/or a switch 234 (e.g., a mechanical or electronic switch) configured to detect a pressure within a fluid line 236 extending between the third directional control valve 220 and the hydraulic cylinder. The pressure within the fluid line 236 may be indicative of whether the pin 78 is in the first position 80 and/or whether engaging members 18 are in the retracted position 74. For example, if the pressure within the fluid line 236 exceeds a predetermined amount or threshold (e.g., stored in the memory 30), the switch 234 may engage, thereby indicating that the pin 78 is in the first position 80 and/or that the engaging members 18 are in the retracted position 74. The switch 234 may be configured to provide a signal indicative of the condition of the switch 234 and of the position of the pin 78 and/or the engaging members 18 to the processor 28 of the controller 20.

As discussed above, the controller 20 may be configured to control any of the various components of the hydraulic fluid system 22, including the pump 200, the one or more velocity fuses 214, and/or the various valves to cause adjustment of the upper surface 11 of the support structure 12 and the engaging members 18 in the manner discussed above to facilitate assembly of the valve 16. For example, in some embodiments, the processor 28 of the controller 20 may be configured to control the pump 200 and/or various valves (e.g., the first directional control valve 204, the second directional control valve 212, etc.) to cause the upper surface 11 of the support structure 12 to move to the lowered position 13, as set forth in step 184 of FIG. 8. Once the upper surface 11 reaches the lowered position 13, the processor 28 of the controller 20 may control the pump 200 and/or various valves (e.g., the first directional control valve 204, the third directional control valve 220, etc.) to cause the engaging members 18 of the tool 10 to expand radially outward to contact the seat 52 of the valve 16, as set forth in step 186 of FIG. 8. The processor 28 of the controller 20 may then control the pump 200 and/or various valves (e.g., the first directional control valve 204, the second directional control valve 212, etc.) to cause the upper surface 11 of the support structure 12 to move to the intermediate position 104 to drive the seat 52 into the second position 100, as set forth in step 188 of FIG. 8.

In some embodiments, the processor 28 of the controller 20 may be configured to receive the signals from the sensor 230 and/or the switch 234 and to control the pump 200 and/or the various valves based at least in part on the signals. For example, the processor 28 of the controller 20 may provide a control signal to pump 200, the first directional control valve 204, and/or the second directional control valve 212 to increase pressure at the hydraulic cylinder 24 to drive the upper surface 11 of the support structure 12 from the intermediate position 104 to the raised position 49 once the pressure detected in the fluid line 236 indicates that the engaging members 18 have returned to the retracted position 74 after assembly of the valve 16.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method for assembling a ball valve using a system having a support structure and a tool, the method comprising:
positioning a body of the ball valve on a surface of the support structure;
driving one or more engaging members of the tool radially outward from a retracted position to an expanded position to engage a seat disposed within the body of the ball valve; and
adjusting an axial position of the surface of the support structure relative to the one or more engaging members of the tool while the seat is engaged by the one or more engaging members of the tool to drive the seat into a seated position within the body of the ball valve.

2. The method of claim 1, comprising inserting a trunnion through a passageway of a ball disposed adjacent to the seat within the body of the ball valve while the seat is held in the seated position by the one or more engaging members of the tool.

3. The method of claim 1, comprising adjusting the axial position of the surface of the support structure relative to the one or more engaging members while the one or more engaging members of the tool are in the retracted position to move the tool to an inserted position in which the one or more engaging members of the tool are axially aligned with the seat to enable the one or more engaging members to engage the seat when driven from the retracted position to the expanded position.

4. The method of claim 1, wherein a biasing member positioned between respective surfaces of the seat and the body is in a compressed state while the seat is in the seated position.

5. The method of claim 1, wherein adjusting the axial position of the surface of the support structure comprises providing a control signal from a processor of a controller to adjust a fluid actuator coupled to the surface of the support structure.

6. The method of claim 1, comprising adjusting an axial position of a pin of the tool to drive the one or more engaging members from the retracted position to the expanded position.

7. The method of claim 6, wherein adjusting the axial position of the pin comprises providing a control signal from a processor of a controller to adjust a fluid actuator coupled to the pin.

8. The method of claim 1, comprising disengaging the one or more engaging members from the seat to enable a biasing member positioned between respective surfaces of the seat and the body to bias the seat toward the ball.

9. The method of claim 8, comprising adjusting the axial position of the surface of the support structure after disengaging the one or more engaging members from the seat to withdraw the tool from the body of the valve.

10. A method for assembling a ball valve using a system having a support structure and a tool, the method comprising:
moving a surface of the support structure in a first direction to align one or more engaging members of the tool with a seat disposed within a body of the ball valve that is positioned on the surface of the support structure;
expanding the one or more engaging members of the tool to engage the seat while the one or more engaging members are aligned with the seat; and
moving the surface of the support structure in a second direction, opposite the first direction, while the one or more engaging members engage the seat to bring the seat into a seated position within the body of the ball valve.

11. The method of claim 10, comprising inserting a trunnion through a passageway of a ball disposed adjacent to the seat within the body of the ball valve while the seat is held in the seated position by the one or more engaging members of the tool.

12. The method of claim 10, comprising adjusting a position of a pin of the tool to cause the one or more engaging members to expand to engage the seat.

13. A system, comprising:
a support structure comprising a surface configured to support a body of a ball valve; and
a tool configured to extend through an opening of the surface of the support structure and into the body of the ball valve, wherein the tool is configured to engage a seat disposed within the body of the ball valve while the surface of the support structure moves relative to tool to drive the seat into a seated position within the body of the ball valve.

14. The system of claim 13, wherein the tool comprises one or more engaging members configured to expand radially outward to engage an inner wall of the seat.

15. The system of claim 13, wherein the tool comprises a pin, the one or more engaging members are positioned circumferentially about the pin, and the pin is configured to move in an axial direction to drive the one or more engaging members from a retracted position in which the one or more engaging members do not engage the seat and an expanded position in which the one or more engaging members engage the seat.

16. The system of claim 15, wherein the tool comprises a hydraulic actuator configured to drive the pin in the axial direction.

17. The system of claim 13, wherein a first passageway extending through a ball disposed in the body is axially aligned with a second passageway extending through the body while the seat is in the seated position, and the first and second passageways are configured to receive a trunnion.

18. The system of claim 13, wherein the surface of the support structure is configured to move from a raised position to a lowered position to cause the tool to extend through the opening of the surface of the support structure and into the body of the ball valve.

19. The system of claim 13, wherein the support structure comprises a stationary base and the tool is coupled to the stationary base.

20. The system of claim 13, wherein the support structure comprises one or more locating tabs extending axially from the surface to contact the body and to facilitate alignment of an opening of the body with the opening of surface of the support structure.
